(19) United States
(12) Patent Application Publication
(10) Pub. No.: US 2015/0379469 A1
(43) Pub. Date: Dec. 31, 2015

(54) CONSOLIDATED CLIENT ONBOARDING SYSTEM

(71) Applicant: Bank of America Corporation, Charlotte, NC (US)

(72) Inventors: Karen Gordon, West Bend, WI (US); Tracy Erin O'Donnell Higgins, St. Augustine, FL (US); Tim A. Meyer, Jacksonville, FL (US); Sam Perone, Jacksonville, FL (US)

(21) Appl. No.: 14/319,873

(22) Filed: Jun. 30, 2014

(51) Int. Cl. G06Q 10/10; G06F 17/30

(52) U.S. Cl. CPC G06Q 10/10; G06F 17/30156; G06F 17/30864

(57) ABSTRACT

A consolidated client onboarding system for improved efficiency and functionality in receiving a plurality of potential new clients into a new business relationship with a business enterprise is presented. The system may be utilized in response to a newly-hired employee requesting to onboard a plurality of potential new clients that represent existing clients associated with the newly-hired employee.

### TECHNICAL FIELD

Aspects of this disclosure generally relate to systems and methods for improving efficiency in receiving and processing new client information by a business enterprise.

### BACKGROUND

In one example, a financial institution may hire a financial advisor, or similar job role, who intends to bring with him/her a plurality of existing clients to be newly-associated with the financial institution. Conventionally, a process for receiving these clients into the financial institution may involve preparation of various documents to be completed by each potential new client. Accordingly, for a large number of existing clients associated with a newly-hired financial advisor, this integration, or onboarding procedure, may be labor intensive, and may take multiple days to process. From the perspective of the example financial institution, the time taken to prepare and process the documents to be executed by each potential new client may represent a significant source of inefficiency.

As such, a need exists for an improved system for client onboarding.

### BRIEF SUMMARY

In light of the foregoing background, the following presents a simplified summary of the present disclosure in order to provide a basic understanding of some aspects of the various implementations of this disclosure. This summary is not an extensive overview of the embodiments described herein. It is not intended to identify key or critical elements, or to delineate the scope of the embodiments described in this disclosure. The following summary merely presents some concepts of the embodiments of this disclosure in a simplified form as a prelude to the more detailed description provided below.

In one aspect, this disclosure relates to an apparatus having a processor in communication with a non-transitory computer-readable medium with computer-executable instructions that receive onboarding data for a plurality of prospective financial institution clients. The computer-executable instructions parse the onboarding data to identify biographic data points associated with a prospective client, as well as identify template forms to be completed by the prospective client in order to associate the prospective client with the financial institution. Further, the computer-executable instructions deduplicate the identified template forms to be completed, populate the deduplicated forms with identified biographic data, communicate the populated forms to the prospective client, and receive the completed forms from the prospective client.

In another aspect, this disclosure includes a computer-implemented method that receives, by a data recognition module, data related to a plurality of prospective clients, and extracts biographic data points from the received data. The method further identifies, by a document interface module, one or more template forms to be completed by prospective clients based on the biographic data points extracted, and deduplicates, by a deduplication module, the identified template forms to remove repeated data requests. Additionally, the method populates, using the document interface module, the deduplicated template forms with extracted biographic data points, and communicates the populated forms to a prospective client. The method further receives, by a document processing module, completed forms from the prospective client.

In yet another aspect, this disclosure relates to one or more non-transitory computer readable media having instructions that, when executed, receives data associated with a plurality of individuals, parses the received data to extract a plurality of biographic data points, identifies one or more template forms to be completed by an individual based upon extracted biographic data points, and deduplicates the template forms of any duplicate forms. The instructions, when executed, further include populating the deduplicated forms with information from the biographic data points, communicating of the populated forms to an individual, and receiving completed forms from the individual.

Aspects of this disclosure address one or more of the issues mentioned above by disclosing methods, systems, non-transitory computer readable media, and apparatuses for onboarding of new clients, or setting up a new business relationship between an individual/entity and a business enterprise. Aspects of the disclosure may also be provided in a non-transitory computer-readable medium having computer-executable instructions to perform one or more of the process steps described herein.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and is not limited in the accompanying figures in which like reference numerals indicate similar elements.

FIG. 1 shows an illustrative operating environment in which various aspects of the disclosure may be implemented.

FIG. 2 depicts an illustrative consolidated onboarding system, according to one or more aspects described herein.

FIG. 3 is an illustrative flowchart diagram describing a process for onboarding prospective client information as well as preparation of forms to be completed by one or more prospective clients, according to one or more aspects described herein.

FIG. 4 is an illustrative flowchart diagram of a process for associating prospective client data with a client account, according to one or more aspects described herein.

FIG. 5 is an illustrative flowchart diagram of one or more deduplication processes, according to one or more aspects described herein.

### DETAILED DESCRIPTION

As discussed above, receiving a plurality of new clients into a new business relationship with a business enterprise may represent a relatively inefficient process/group of processes. This inefficiency may be of particular note when a newly-hired employee of the business enterprise intends to bring with him/her a plurality of existing clients associated with the new employee. In one example, the business enterprise may be obliged to prepare one or more forms to be executed by each potential new client of the business enterprise (from those existing clients associated with the new employee). As such, during the time taken to prepare, have executed, receive and process the executed forms, the business enterprise may not be able to offer one or more business services to the potential new client. Those of ordinary skill in the art will recognize that such a source of inefficiency may be undesirable for business enterprises of various forms, including, among others, a financial institution (a commercial bank, an investment bank, an insurance company, a brokerage, an investment company, a unit investment trust, a management investment company, among others), a credit union, a law firm, a business management consultancy firm, or an engineering consultancy firm, or combinations thereof.

In the description that follows, a consolidated client onboarding system is described for use in a financial institution. Those of ordinary skill in the art will recognize, however, that such a consolidated client onboarding system may be utilized with one or more additional or alternative business enterprise types, without departing from the scope of the disclosures described herein. As such, a consolidated client onboarding system may allow for improved efficiency and functionality in receiving a plurality of potential new clients into a new business relationship with a financial institution, and in response to a newly-hired employee of the financial institution requesting to onboard (or integrate into one or more business services offered by the financial institution) the plurality of potential new clients who represent existing clients associated with the newly-hired employee. In one specific example, a newly-hired employee may be a financial advisor, and the plurality of potential new clients may be clients that the financial advisor is requesting to transfer from being associated with another financial institution.

Conventionally, a request to onboard a plurality of potential new clients into a financial institution may be delayed by one or more processes carried out to receive information associated with the potential new clients, prepare information as well as forms to be executed by the potential new clients, communicate or transmit the forms to the potential new clients, and receive and process the executed forms. Such delays represent periods of time during which the financial institution may not be able to offer one or more services to the potential new clients. Advantageously, the consolidated client onboarding system described herein may be utilized to achieve improved efficiency with regard to one or more onboarding processes, thereby reducing the time during which a financial institution may not be able to offer one or more financial services to the potential new clients.

In the context of this disclosure, a consolidated client onboarding system, otherwise referred to as a consolidated client onboarding device, may comprise hardware, firmware, and/or software utilized to integrate various processes to improve efficiency in providing access to one or more services offered by a financial institution. Accordingly, those of ordinary skill in the art will recognize various financial services that may be offered by a financial institution, and which may include, among others, savings services, investment services, trust services, insurance services, or combinations thereof. As such, those of ordinary skill in the art will recognize that any financial service offered by a financial institution may be practiced in combination with the consolidated client onboarding system described herein.

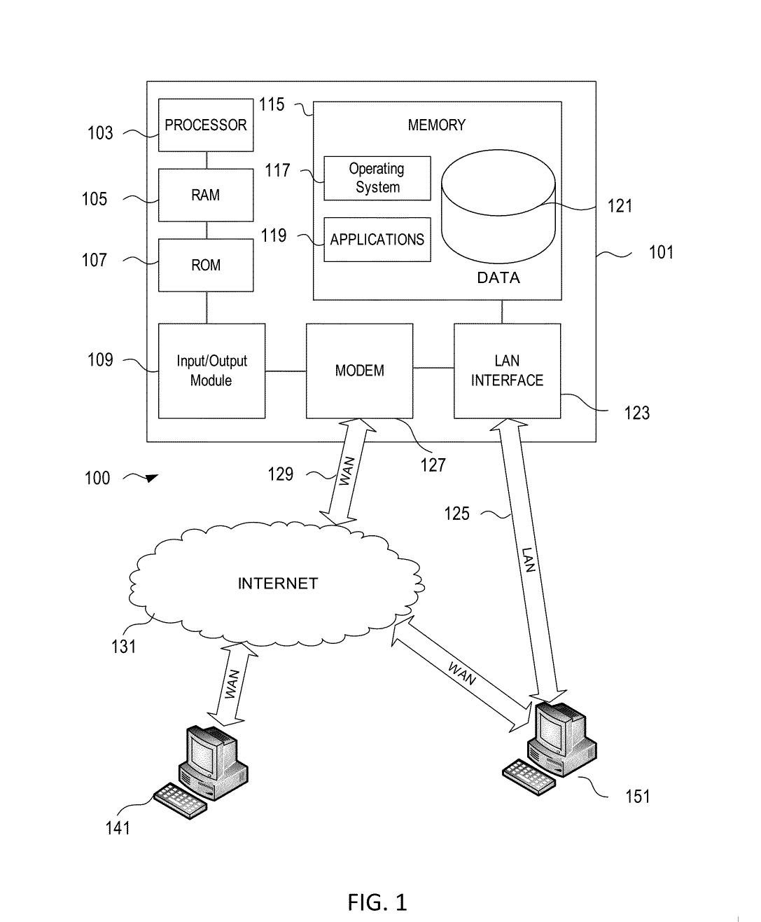

Accordingly, and with reference to FIG. 1, the consolidated client onboarding system may be implemented as a general-purpose or specialized computing system 100. As such, the consolidated client onboarding system may include one or more network-linked computer devices, such as devices 101, 141, and/or 151. Furthermore, the consolidated client onboarding system 100 may be implemented on consolidated computing hardware, such as computing device 101, at a single geographic location, and/or on a single integrated circuit, and the like. In another example, the consolidated client onboarding system 100 may be implemented across multiple computing devices at a common geographic location, or at dispersed geographic locations. As such, device 100 may comprise computing devices 101, 141, and/or 151 in communication with one another using one or more networking technologies (125, 129, and/or 131) described in further detail in the description that follows.

In one example implementation, computing device 101 may have a processor 103 for controlling overall operation of device 101 and its associated components, including RAM 105, ROM 107, an input/output (I/O) module 109, and memory 115. In one example, as will be apparent to those of ordinary skill in the art, memory 115 may comprise any known form of persistent and/or volatile memory, such as, among others, a hard disk drive, a solid state disk, optical disk technologies (CD-ROM, DVD, Blu-ray, and the like), tape-based stored devices, ROM, and RAM, or combinations thereof. In this way, memory 115 may comprise a non-transitory computer-readable medium that may communicate instructions to processor 103 to be executed.

I/O module 109 may include a microphone, keypad, touch screen, and/or stylus through which a user of the computing device 101 may provide input, and may also include one or more of a speaker for providing audio output and a video display device for providing textual, audiovisual and/or graphical output. Software may be stored within memory 115 and/or storage to provide instructions to the processor 103 for allowing the computing device 101 to perform various functions. For example, memory 115 may store software used by the computing device 101, such as an operating system 117, application programs 119, and an associated database 121. The processor 103 and its associated components may allow the computing device 101 to run a series of computer-readable instructions to process and format data.

The computing device 101 may operate in a networked environment supporting connections to one or more remote computers, such as computing devices 141 and 151. In one example, the computing devices 141 and 151 may be personal computers or servers that include many, or all, of the elements described above relative to the computing device 101. Alternatively, computing device 141 and/or 151 may be a data store that is affected by the operation of the computing device 101. The network connections depicted in FIG. 1 include a local area network (LAN) 125 and a wide area network (WAN) 129, but may also include other networks. When used in a LAN networking environment, the computing device 101 is connected to the LAN 125 through a network interface or adapter 123. When used in a WAN networking environment, the computing device 101 may include a modem 127 or other means for establishing communications over the WAN 129, such as the Internet 131. It will be appreciated that the network connections shown are illustrative, and other means of establishing a communication link between the computers may be used. The existence of any of various well-known protocols such as TCP/IP, Ethernet, FTP, HTTP and the like is presumed. Accordingly, communication between one or more of computing devices 101, 141, and/or 151 may be wired or wireless, and may utilize Wi-Fi, a cellular network, Bluetooth, infrared communication, or an Ethernet cable, among many others.

Additionally, an application program 119, used by the computing device 101 according to an illustrative embodiment of the disclosure, may include computer-executable instructions for invoking functionality related to providing a user interface having consolidated and tailored access to information associated with onboarding one or more clients into a financial institution.

The computing device 101 and/or the other devices 141 or 151 may also be mobile devices, such as smart phones, personal digital assistants (PDAs), and the like, which may include various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, and the like that perform particular tasks or implement particular abstract data types. The disclosure may also be practiced in distributed computing environments where tasks are performed by remote processing devices that are linked, for example, through a communications network. In a distributed computing environment, program modules may be located in both local and remote computer storage media including memory storage devices.

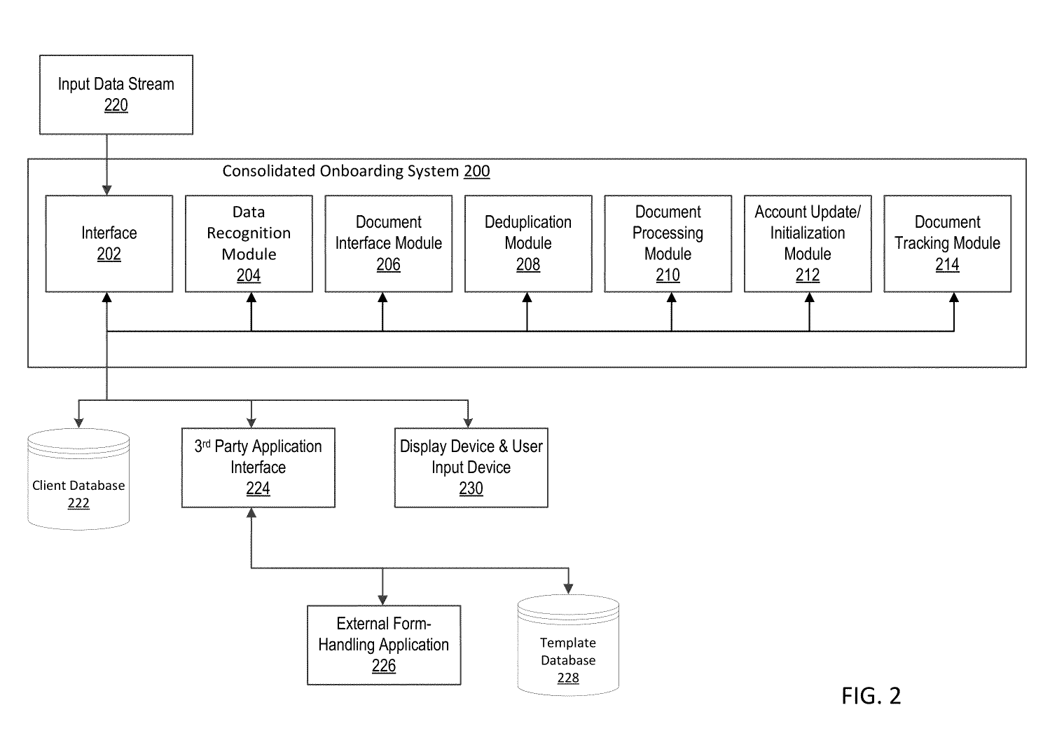

FIG. 2 is a schematic block diagram that includes a consolidated onboarding system 200. In one implementation, the consolidated onboarding system 200 is configured as a single computer system similar to one or more of devices 101, 141, and/or 151 from FIG. 1. As such, the consolidated onboarding system 200 may comprise one or more processors, such as processor 103, each having one or more processing cores. In this implementation, the consolidated onboarding system 200 may be located at a single geographic location.

Additionally or alternatively, consolidated onboarding system 200 may comprise distributed hardware between which information is communicated across one or more computer network types. As such, the consolidated onboarding system 200 may comprise one or more hardware sub-components in communication with one another using any known network communication protocol, and utilizing a LAN, a WAN, the Internet, a Wi-Fi connection, or a Bluetooth connection, among others. Accordingly, in one example, the consolidated onboarding system 200 may be distributed across different geographic locations.

In one example, the consolidated onboarding system 200 comprises an interface module 202. As such, interface module 202 may comprise hardware, and supporting software and/or firmware, configured to facilitate communication between the consolidated onboarding system 200 and one or more databases, user interfaces, or additional systems associated with a computer network of a financial institution, among others. Accordingly, interface module 202 may comprise one or more physical connector ports as well as one or more integrated circuits or other electronic hardware configured to send and/or receive electronic signals carrying digitally-encoded information (interface module 202 may, additionally or alternatively, be utilized with analog signals). In particular, interface module 202 may comprise, among others, one or more USB ports, Ethernet ports, IEEE 1394 interfaces, parallel ports, VGA ports, HDMI ports, PCI ports, DVI ports, or any other known interface type, and of any known version type.

The consolidated onboarding system 200 comprises various additional modules 204-214 that are described in further detail below. As such, those of ordinary skill in the art will recognize that these modules 204-214 may communicate with the interface module 202 using one or more of physical hardware links and/or software communication processes of any type capable of communicating digital information as described throughout this disclosure.

In one implementation, the consolidated onboarding system 200 comprises a data recognition module 204, otherwise referred to as a parsing module. As such, the data recognition module 204 may be configured to execute one or more processes to receive a group of data associated with one or more prospective clients to be onboarded into (e.g., have a new business relationship established with) a financial institution. In one example, the data recognition module 204 may receive data associated with a plurality of prospective clients (clients associated with a newly-hired financial advisor into a financial institution who may not currently have a business relationship with the financial institution, among others) from the interface module 202. In turn, the data associated with a plurality of prospective clients may be received into the interface module 202 from an input data stream 220. Accordingly, those of ordinary skill in the art will recognize that the input data stream 220 may comprise one or more different types of input data. In one example, the input data stream 220 may comprise a digital spreadsheet containing biographic information associated with a plurality of individuals, or other legal entities (corporations, limited liability practices, among others). As such, a digital spreadsheet containing biographic information associated with a plurality of individuals/other legal entities may have a known formatting convention, or may be unformatted. Additionally or alternatively, input data stream 220 may comprise a single digital file, or a group of digital files of any known file type (proprietary or nonproprietary file types), or having a combination of different file types. Further, the input data stream 220 may comprise “raw” digitally- or analog-encoded information. Additionally or alternatively, input data stream 220 may include encrypted information encrypted using any encryption methodology known to those of ordinary skill in the art. Further, data received into, processed within, and/or produced by the consolidated onboarding system 200 may utilize any one or more encryption methodologies known to those of ordinary skill in the art.

Upon receipt of data associated with one or more potential clients, the data recognition module 204 may execute one or more processes to open and read (in one example, read into memory, such as memory 115 from FIG. 1) all or part of the information associated with the received data. This information may include metadata, in addition to biographic information (biographic data points) associated with one or more potential new clients of the financial institution. In one example, the data recognition module 204 may parse, or identify and extract, one or more specific data types from a data set received. As such, the data recognition module 204 may execute one or more processes to recognize one or more specific datatypes based upon, among others, a naming convention, a formatting convention, information contained within metadata received with the received data set, among others. In one specific example, the data recognition module 204 may parse, or identify and extract, one or more specific datatypes including, a name of an individual or legal entity, an address associated with an individual or legal entity, information related to one or more accounts held at another financial institution from which the individual or legal entity is to be transferred, details related to previous services rendered to the individual or legal entity by a newly-hired financial advisor, or any other identifying information that may be utilized in transferring/integrating a potential new client into a financial institution. Accordingly, those of ordinary skill in the art will recognize that the data recognition module 204 may utilize any known file parsing/file data recognition and extraction methodologies without departing from the scope of the disclosures described herein.

The consolidated onboarding system 200 may further comprise a document interface module 206, otherwise referred to as an interface module. Accordingly, in one example, the document interface module 206 may execute one or more processes to communicate information back and forth between the consolidated onboarding system 200 and a third-party application interface 224. In turn, the third-party application interface 224 may be configured to execute one or more processes to communicate with an external form-handling application 226. As such, in the context of this disclosure, the external form-handling application 226 may comprise any application configured to communicate or transmit forms to be electronically completed (information added to and/or electronically signed) and returned to the sender. Additionally, the external form-handling application 226 may communicate information to the third-party application interface 224 indicative of a status of forms communicated via the external form-handling application 226. This status information may include an indicator as to whether communicated forms have been received, opened, executed, and/or returned to the third-party application interface 224, among others.

Accordingly, in one implementation, the third-party application interface 224 may comprise one or more of hardware, firmware and software configured to execute one or more processes to allow the consolidated onboarding system 200 to generally communicate with a plurality of different software application types. As such, the third-party application interface 224 may serve as an interface between the consolidated onboarding system 200 and a general-purpose or specialized operating system running on a computer system, or as an interface between the consolidated onboarding system 200 and one or more applications configured to execute within an operating system environment.

Returning to the document interface module 206, in one example, the module 206 may communicate one or more data points/pieces of information to be used to populate one or more template forms to be communicated to a prospective client(s) via the third-party application interface 224 and the external form-handling application 226. In one implementation, the information to be used to populate one or more template forms may correspond to information parsed/extracted from the input data stream 220 by the data recognition module 204. As such, the document interface module 206 may communicate, via the third-party application interface 224, with a template database 228. The template database 228, in turn, may store a plurality of template forms that may be populated with information parsed from the input data stream 220. Those of ordinary skill in the art will recognize that the template database 228 may store forms of any known variety, and that a form may comprise text information, or may comprise additional or alternative forms of information including audio and video information.

In one example, the external form-handling application 226 may receive information from the document interface module 206 and utilize part or all of the received information to populate various data fields associated with one or more template forms extracted from the template database 228. Additionally, the external form-handling application 226 may receive information from the document interface module 206 detailing the intended recipients of the template forms to be populated, among others.

The consolidated onboarding system 200 may comprise a deduplication module 208. In one example, the deduplication module 208 may be configured to execute one or more processes to deduplicate, or reduce or eliminate repeated, or duplicated, requests for information from a prospective client. For example, the deduplication module 208 may communicate with one or more of the document interface module 206 and the template database 228 to analyze those identified template forms to be communicated to a prospective client. In one example, the deduplication module 208 may identify duplicated forms, from a plurality of forms to be communicated to an individual, and execute one or more processes to remove the one or more duplicate copies of a form before communication of a packet of forms to the individual. In another example, the deduplication module 208 may execute one or more processes to identify duplicate requests for information within a single form, or across multiple forms. In this way, the deduplication module 208 may identify duplicate lines (including duplicate text input fields) appearing in one or more forms to be communicated to a user. In response, the deduplication module 208 may execute one or more processes to edit one or more forms by removing the duplicated portions (wherein a duplicated portion may be part of a form). In this way, the deduplication module 208 may comprise one or more processes configured to read the content of one or more template forms. As such, the deduplication module 208 may comprise one or more optical character recognition processes configured to interpret the contents of one or more template forms as known text characters.

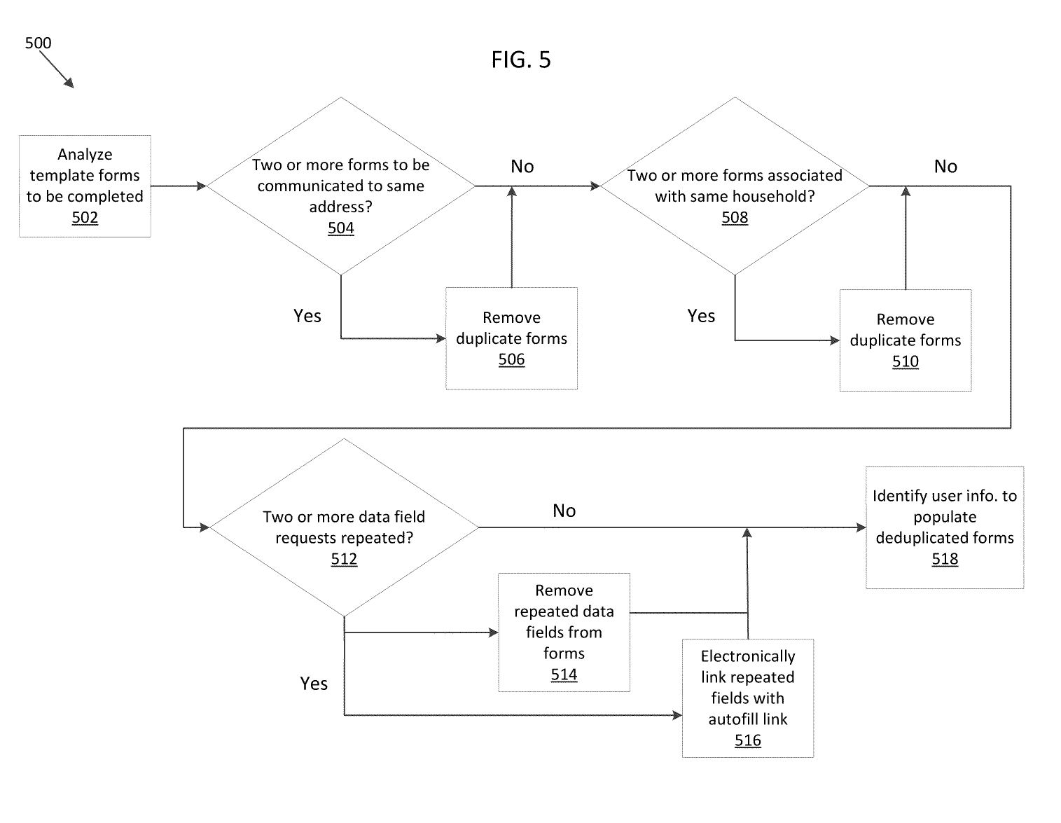

In yet another example, the deduplication module 208 may be configured to identify one or more duplicate forms, or one or more duplicate requests for information, wherein the duplicate requests may be present as part of a same form (for example a line, a sub-section), or different forms. In response, the deduplication module 208 may be configured to electronically link the duplicated/repeated sections, or input information requests, such that when a user electronically inserts (fills-in) information into a first text field, a repeated or duplicated text field in another section of a same form, or another associated form, is automatically filled with the same inputted information. In this way, the consolidated onboarding system 200 may be utilized to reduce the amount of information requested of an individual or other entity to which one or more forms are to be communicated for execution. As such, this reduction in information requests may be associated with a reduction in an amount of time taken to complete the one or more forms communicated to a user, and thereby increase efficiency. Further details of deduplication are described in relation to FIG. 5.

In one implementation, the consolidated onboarding system 200 further comprises a document processing module 210, otherwise referred to as a processing module. Accordingly, in one example, the document processing module 210 may be configured to execute one or more processes to receive one or more completed forms from the third-party application interface 224 and the external form-handling application 226. As such, the document processing module 210 may be configured to, among others, store those completed documents and/or communicate the completed documents to the data recognition module for further processing. This further processing may include analysis of the completed forms to determine whether the requested data fields (e.g., text input fields) have been filled out, among others. Further, the document processing module 210 may be configured to receive completed forms (partially or wholly completed) received via electronic means (email, internet, intranet, fax), or via physical mail. Accordingly when receiving completed documents via physical mail, document processing module 210 may be configured to scan (digitally image) a received physical copy of a completed form into a digital copy of the completed form, and to further perform one or more character recognition processes on the scanned document.

In one example, the consolidated onboarding system 200 comprises an account update and initialization module 212. This account update and initialization module 212 may be configured to, upon extraction of biographic information from the input data stream 220 by the data recognition module 204, determine whether a prospective client, from the plurality of prospective client data contained within the input data stream 220, has an existing business relationship (account) with the financial institution. As such, module 212 may be configured to execute one or more processes to search a client database 222 associated with the financial institution for an existing one or more accounts associated with the identified prospective client. Those of ordinary skill in the art will recognize that the client database 222 may comprise account information for one or more clients associated with the financial institution, and utilize any known database hardware, firmware, and/or software configured to facilitate secure storage of account information using any known access and/or encryption methodologies.

In one implementation, if the module 212 determines that the identified prospective client already has an account with the financial institution, the module 212 may be configured to update account information using information extracted by the data recognition module 204 from the input data stream 220. If, however, the module 212 determines that the identified prospective client does not have an existing business relationship (account) with the financial institution, module 212 may be configured to attempt to open an account.

In particular, the account update and initialization module 212 may be configured to execute one or more processes to test whether the information identified by the data recognition module 204 is sufficient to open/initialize a new account with the financial institution. In one example, this testing may determine whether one or more biographic data points extracted from the input data stream 220 by the data recognition module 204 may be utilized to complete an account initialization questionnaire/automated form. As such, the account update and initialization module 212 may determine that there is an insufficient amount of information available to open a new account, and in response, may execute one or more processes to instruct the document interface module 206 to request additional information with/separate from a packet of populated template forms to be communicated to a prospective client. In another example, the account update and initialization module 212 may determine that there is a sufficient amount of information available to open a new account, and in response, may execute one or more processes to open an account in the financial institution. In one example, account initialization information may be stored in client database 222, among others.

The consolidated onboarding system 200 may further comprise a document tracking module 214 configured to receive information from the external form-handling application 226 indicative of a status of one or more forms communicated to a prospective client. This status information may describe, among others, that the one or more forms have been: delivered to the prospective client, viewed by the prospective client, executed by the prospective client, and/or returned to the consolidated onboarding system 200. Additionally or alternatively, the document tracking module 214 may be configured to identify one or more completed/executed forms received by the consolidated onboarding system 200. In this way, the document tracking module 214 may identify the one or more completed forms based upon a unique identifier associated with each template form before communication to the respective client. Those of ordinary skill in the art will recognize various unique identifiers that may be associated with a form including, among others, a form ID number, a filename, one or more markers in metadata associated with a file, or combinations thereof.

It will be readily apparent to those of ordinary skill in the art that the consolidated onboarding system 200 may be configured, via interface module 202, to facilitate one or more user interfaces including, among others, a graphical user interface displayed on a display device, and/or an information input interface facilitated by an input device (keyboard, mouse, touchscreen, voice command among others). Accordingly, in one example, the consolidated onboarding system 200 may communicate with a user within a financial institution via the display device and user input device schematically depicted as element 230.

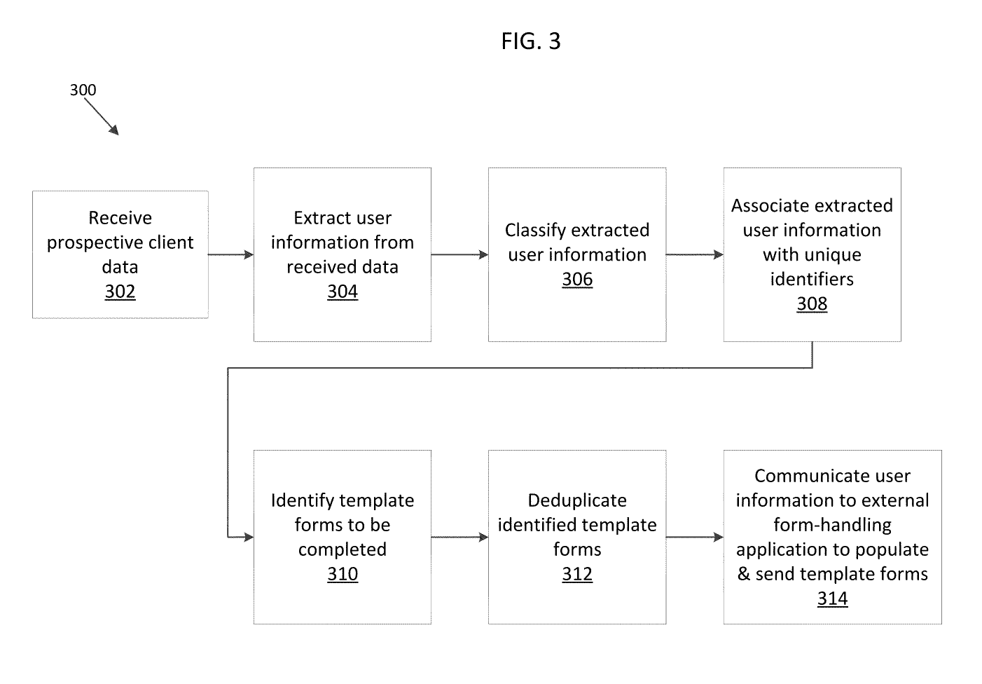

FIG. 3 is a flowchart diagram describing a process 300 for onboarding prospective client information as well as preparation of forms to be completed by one or more prospective clients. In one example, a consolidated onboarding system, such as onboarding system 200 from FIG. 2, is configured to execute one or more processes to receive data associated with a plurality of prospective clients. This data may be further associated with an individual newly-hired into a business enterprise (in one example, a newly-hired financial advisor into a financial institution). Accordingly, in one example, receipt of prospective client data may be associated with block 302 of flowchart 300. Data associated with a plurality of prospective clients may be received by a data recognition module, such as module 204 from FIG. 2.

Process 300 may further execute one or more sub-processes to extract user information data points from the received data associated with the plurality of prospective clients. Accordingly, in one example, a data recognition module, such as module 204 from FIG. 2, may be configured to execute one or more processes to parse received data into separate data points. In one example, this data extraction may be carried out as block 304 of process 300.

In one implementation, process 300 may comprise one or more processes to classify extracted user information. In particular, parsed data may be classified based on one or more identified data types. As such, the one or more identified data types may include, among others, names, addresses, current financial institution associations, additional biographic information (social security number, date of birth, and the like), or combinations thereof. Accordingly, one or more classification processes may be executed at block 306 of process 300.

One or more processes may be executed to associate extracted user information with one or more unique identifiers. In particular, these one or more processes may be executed at block 308. As such, extracted user information may be associated with one or more unique identifiers including, among others, a specific family name (last name of a user), a household identifier (a residential/commercial address), or a master account number. In one implementation, classification of extracted user information, in addition to association with one or more unique identifiers, may be executed by a data recognition module, such as module 204 from FIG. 2. As such, the extracted information, the identified classifications, in addition to the associations with unique identifiers, may be stored in local memory, such as RAM 105 and/or memory 115 from FIG. 1.

Process 300 may further comprise one or more sub-processes executed to identify one or more template forms to be completed by one or more prospective clients. In particular, a document interface module, such as module 206 from FIG. 2, may be utilized to identify one or more template forms to be completed by a prospective client based upon extracted information, such as that information extracted at block 304. As such, process 300 may identify one or more template forms to be completed at block 310.

In one example, deduplication may be utilized to reduce an amount of information requested to be inputted into one or more forms by a user (e.g., prospective client). In particular, deduplication may be utilized to remove duplicate copies of forms to be communicated to a prospective client, to remove duplicated text fields from two or more sub-sections of a same form, or different forms, and/or to link duplicated requests for client information using an electronic auto-fill link(s), among others. In one example, deduplication may be executed by a deduplication module, such as module 208 from FIG. 2, and may be executed at block 312 of process 300. Deduplication is described in further detail in relation to FIG. 5.

In one implementation, process 300 proceeds to communicate user information extracted, in one example, at block 304, to a document interface module, such as module 206 from FIG. 2. As such, the document interface module 206 may be utilized to communicate with an external form-handling application to populate and communicate one or more template forms to one or more selected prospective clients. As such, these one or more processes to populate and communicate template forms to prospective clients may be executed at block 314 of process 300.

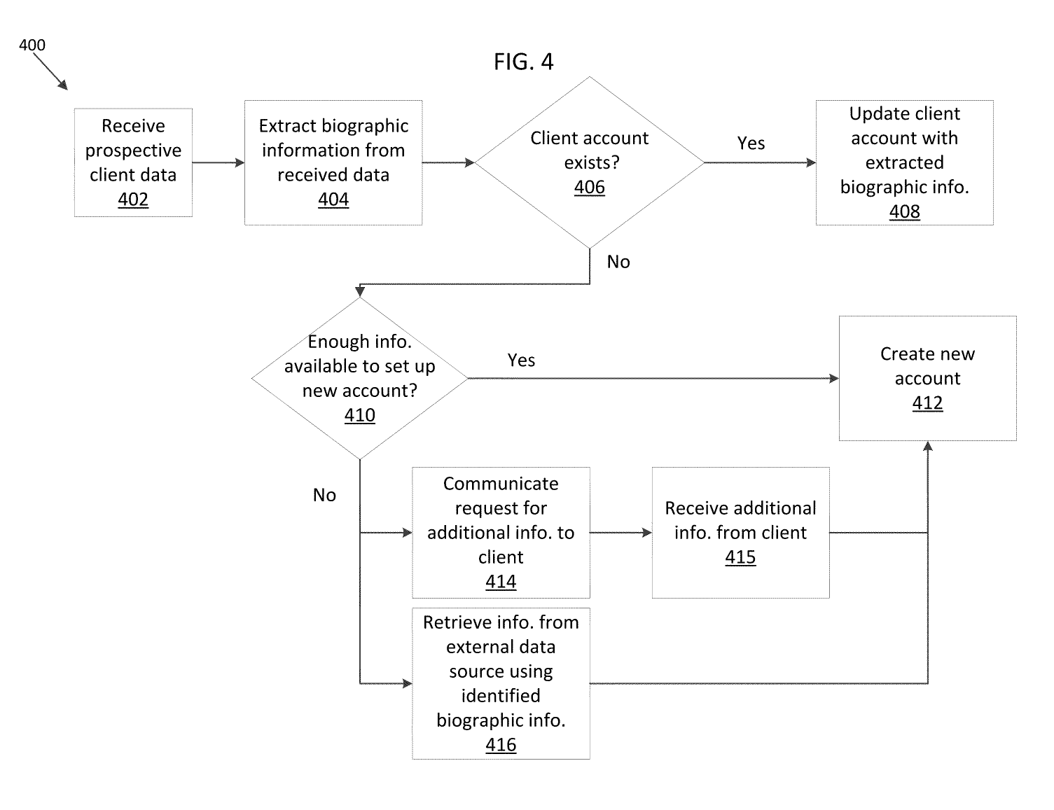

FIG. 4 is a flowchart diagram describing a process 400 for associating prospective client data with a client account. In one example, process 400 receives prospective client data from an input data stream, such as stream 220 from FIG. 2. This receipt of prospective client data may be associated with block 402 of process 400. Further, in one implementation, receipt of this prospective client data may be by a data recognition module, such as module 204 from FIG. 2.

Process 400 may execute one or more sub-processes to extract user information from received data. As such, this extraction may be executed by a data recognition module, such as module 204 from FIG. 2. Accordingly, this extraction of user information may be associated with block 404 of process 400.

Process 400 may perform a check as to whether user information extracted at block 404 is associated with an existing account (check whether there is an existing business relationship between a user identified from the received prospective client data and the financial institution). In one example, this check may be performed at decision block 406. If an identified prospective client already has an account with the financial institution, process 400 proceeds to block 408, wherein one or more processes are executed to update one or more client accounts with information extracted at block 404. If, however, no account exists in the financial institution for the identified prospective client, process 400 proceeds to block 410, wherein a check is performed to determine whether there is enough information available, from the information extracted at block 404, to set up a new account. If there is enough information to set up a new account, process 400 proceeds to block 412, wherein an accounts initialization module, such as module 212 from FIG. 2, creates a new account for the identified prospective client. If, however, there is not enough information to set up a new account, process 400 proceeds to block 414, wherein a request is communicated to the prospective client for additional information. In one example, this request may be communicated by a document interface module, such as module 206 from FIG. 2. In one example, the requested additional information may be received at block 415, wherein said additional information may be received by, a document processing module, such as module 210 from system 200. Alternatively, if it is determined that there is not enough information to set up a new account, process 400 may proceed to block 416, wherein information may be retrieved from an external data source using information identified at block 404. In one example, this external data source may be a credit score reporting data source, among others.

FIG. 5 is a flowchart diagram of a deduplication process 500. In one example, the deduplication process 500 may be executed by a deduplication module, such as module 208 from FIG. 2. In one example, a deduplication process 500 may analyze template forms to be completed by one or more prospective clients. Accordingly, this analysis may be carried out at block 502 of process 500. In one example, this analysis may comprise optical character recognition of the contents of one or more template forms, reading the recognized text into memory, such as memory 115 from FIG. 1, and analysis of the read text in memory for duplicated/substantially similar occurrences of requests for information, among others. In another example, deduplication may comprise one or more processes to recognize duplicate forms in a packet of forms to be communicated to a prospective client based upon a filename or a file identifier (file number, among others). In another implementation, a template form may be stored as in a computer-searchable format without using character recognition processes.

Decision block 504 represents one or more processes executed to determine whether there exists two or more forms, within a group/packet of forms to be communicated to prospective client, which are to be communicated to a same address (geographic address, email address, IP address, among others). If it is determined, at block 504, that two or more forms are to be communicated to a same address associated with a prospective client, process 500 may proceed to block 506, wherein one or more sub-processes are executed to remove one or more duplicate forms from the group of forms.

Decision block 508 represents one or more processes executed to determine whether two or more forms, from a packet of forms to be communicated to prospective client, are associated with the same household (e.g., a same family name/last name, or a legal connection between two or more individuals in a same household (marriage, and the like)), and contain substantially similar information. If it is determined, at block 508, that two or more substantially similar forms are associated with a same household, process 500 proceeds to block 510, wherein a deduplication module, such as module 208, executes one or more processes to remove the substantially similar duplicate forms from the packet of forms to be communicated to a prospective client/clients.

Decision block 512 represents one or more processes executed to determine whether there are repeated/duplicated data field requests within a single form, or multiple forms to be communicated to a prospective client. Accordingly, decision block 512 may represent one or more processes to analyze multiple sub-sections of one or more forms for substantially similar language. If it is determined that two or more data fields request substantially similar information, process 500 may proceed to block 514. Accordingly, block 514 may execute one or more processes to edit one or more forms by removal of repeated data fields. Additionally or alternatively, upon determining that there exists two or more data fields with substantially similar requests for information from a user or prospective client, process 500 may proceed to block 516, wherein a deduplication module 208 may electronically link duplicated data fields with one or more autofill links. As such, an autofill link may facilitate a user entering information into a first text entry field in a form, and automatically fill that same information into a second text entry field determined, by the deduplication module 208, to be substantially similar to the first text entry field insofar as the information requested from the user is substantially the same.

In one implementation, the deduplication process 500 may identify user information to populate the deduplication forms. In particular, this identification of user information may be executed at block 518. Accordingly, this identified user information may be received from a data recognition module, such as module 204, the functionality of which is described in further detail in relation to FIG. 2 and FIG. 3.

The various embodiments described herein may be implemented by general-purpose or specialized computer hardware. In one example, the computer hardware may comprise one or more processors, otherwise referred to as microprocessors, having one or more processing cores configured to allow for parallel processing/execution of instructions. As such, the various disclosures described herein may be implemented as software coding, wherein those of skill in the computer arts will recognize various coding languages that may be employed with the disclosures described herein. Additionally, the disclosures described herein may be utilized in the implementation of application-specific integrated circuits (ASICs), or in the implementation of various electronic components comprising conventional electronic circuits (otherwise referred to as off-the-shelf components). Furthermore, those of ordinary skill in the art will understand that the various descriptions included in this disclosure may be implemented as data signals communicated using a variety of different technologies and processes. For example, the descriptions of the various disclosures described herein may be understood as comprising one or more streams of data signals, data instructions, or requests, and physically communicated as bits or symbols represented by differing voltage levels, currents, electromagnetic waves, magnetic fields, optical fields, or combinations thereof.

One or more of the disclosures described herein may comprise a computer program product having computer-readable medium/media with instructions stored thereon/therein that, when executed by a processor, are configured to perform one or more methods, techniques, systems, or embodiments described herein. As such, the instructions stored on the computer-readable media may comprise actions to be executed for performing various steps of the methods, techniques, systems, or embodiments described herein. Furthermore, the computer-readable medium/media may comprise a storage medium with instructions configured to be processed by a computing device, and specifically a processor associated with a computing device. As such the computer-readable medium may include a form of persistent or volatile memory such as a hard disk drive (HDD), a solid state drive (SSD), an optical disk (CD-ROMs, DVDs), tape drives, floppy disk, ROM, RAM, EPROM, EEPROM, DRAM, VRAM, flash memory, RAID devices, remote data storage (cloud storage, and the like), or any other media type or storage device suitable for storing data thereon/therein. Additionally, combinations of different storage media types may be implemented into a hybrid storage device. In one implementation, a first storage medium may be prioritized over a second storage medium, such that different workloads may be implemented by storage media of different priorities.

Further, the computer-readable media may store software code/instructions configured to control one or more of a general-purpose, or a specialized computer. Said software may be utilized to facilitate interface between a human user and a computing device, and wherein said software may include device drivers, operating systems, and applications. As such, the computer-readable media may store software code/instructions configured to perform one or more implementations described herein.

Those of ordinary skill in the art will understand that the various illustrative logical blocks, modules, circuits, techniques, or method steps of those implementations described herein may be implemented as electronic hardware devices, computer software, or combinations thereof. As such, various illustrative modules/components have been described throughout this disclosure in terms of general functionality, wherein one of ordinary skill in the art will understand that the described disclosures may be implemented as hardware, software, or combinations of both.

The one or more implementations described throughout this disclosure may utilize logical blocks, modules, and circuits that may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The techniques or steps of a method described in connection with the embodiments disclosed herein may be embodied directly in hardware, in software executed by a processor, or in a combination of the two. In some embodiments, any software module, software layer, or thread described herein may comprise an engine comprising firmware or software and hardware configured to perform embodiments described herein. Functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An example storage medium is coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

Accordingly, it will be understood that the invention is not to be limited to the embodiments disclosed herein, but is to be understood from the following claims, which are to be interpreted as broadly as allowed under the law.

What is claimed is:

1. A consolidated client onboarding apparatus comprising:
a processor; and
a non-transitory computer-readable medium comprising computer-executable instructions that when executed by the processor are configured to:
receive onboarding data associated with one or more prospective clients to a financial institution;
parse the onboarding data to identify one or more biographic data points associated with a selected prospective client, from the one or more prospective clients;
identify one or more template forms to be completed by the selected prospective client based upon the one or more biographic data points;
deduplicate the identified one or more template forms of any duplicate forms identified in the one or more identified template forms;
populate the one or more deduplicated forms with information identified from the one or more biographic data points; and
communicate the one or more populated forms to the selected prospective client.

2. The apparatus of claim 1, wherein the non-transitory computer-readable medium comprising computer-executable instructions that when executed by the processor are further configured to:
identify whether the selected prospective client has an account with the financial institution, wherein, upon determining that the selected prospective client does not have an account with the financial institution, open an account.

3. The apparatus of claim 2, wherein the non-transitory computer-readable medium comprising computer-executable instructions that when executed by the processor are further configured to:
test, upon determining that the selected prospective client does not have an account with the financial institution, whether the one or more biographic data points contains a sufficient amount of information to open an account,
wherein if it is determined that there is insufficient information to open an account, communicate a request for additional information with the one or more populated forms, and
wherein if it is determined that there is sufficient information, open a new account.

4. The apparatus of claim 1, wherein the any duplicate forms are identified based upon a common address associated with two of the one or more identified template forms.

5. The apparatus of claim 1, wherein the any duplicate forms are identified based upon a common last name associated with two of the one or more identified template forms.

6. The apparatus of claim 1, wherein the completed documents are received electronically.

7. The apparatus of claim 1, wherein the completed documents are received via physical mail.

8. The apparatus of claim 1, wherein the non-transitory computer-readable medium comprising computer-executable instructions that when executed by the processor are further configured to:
receive data from an external form-handling application indicating that the one or more populated forms have been completed.

9. The apparatus of claim 1, wherein the onboarding data is received in a digital spreadsheet.

10. A computer-implemented method, comprising:
receiving, by a data recognition module, data associated with one or more prospective clients to a financial institution;
extracting, from the received data, by the data recognition module, one or more biographic data points associated with a selected prospective client, from the one or more prospective clients;
identifying, by a document interface module, one or more template forms to be completed by the selected prospective client based upon the one or more biographic data points;
deduplicating, by a deduplication module, the identified one or more template forms of any duplicate data requests in the one or more identified template forms;
populating, by the document interface module, the one or more deduplicated forms with information identified from the one or more biographic data points; and
communicating, by the document interface module, the one or more populated forms to the selected prospective client.

11. The computer-implemented method of claim 10, further comprising:
identifying, by an account update module, whether the selected prospective client has an account with the financial institution, and upon a determination, by the account update module, that the selected prospective client does not have an account with the financial institution, opening an account.

12. The computer-implemented method of claim 11, further comprising:
testing, by an account initialization module in response to a determination that the selected prospective client does not have an account with the financial institution, whether the one or more biographic data points contains a sufficient amount of information to open an account,
wherein if it is determined that there is insufficient information to open an account, communicating, by the document interface module, a request for additional information with the one or more populated forms, and
wherein if it is determined that there is sufficient information, opening, by the account initialization module, a new account.

13. The computer-implemented method of claim 11, wherein deduplicating the identified one or more template forms further comprises:
identifying, by the deduplication module, the any duplicate data requests based upon a common address associated with the any duplicate data requests.

14. The computer-implemented method of claim 11, wherein deduplicating the identified one or more template forms further comprises:
identifying, by the deduplication module, the any duplicate data requests based upon a common last name associated with the identified one or more template forms.

15. The computer-implemented method of claim 11, wherein deduplicating the identified one or more template forms further comprises:
electronically-linking two or more substantially similar information requests within the identified one or more template forms.

16. The computer-implemented method of claim 11, further comprising:
identifying, by the document processing module, the completed forms based on one or more unique identifiers associated with the one or more populated forms communicated to the selected prospective client.

17. One or more non-transitory computer-readable media having instructions stored thereon that, when executed, cause at least one computing device to:
receive data associated with one or more individuals;
parse, from the received data, one or more biographic data points associated with a selected individual, from the one or more individuals;
identify one or more template forms to be completed by the selected individual based upon the one or more biographic data points;
deduplicate the identified one or more template forms of any duplicate forms in the one or more identified template forms;
populate the one or more deduplicated forms with information identified from the one or more biographic data points; and
communicate the one or more populated forms to the selected individual.

18. The one or more non-transitory computer-readable media of claim 17, wherein the data is received from an electronic spreadsheet.

19. The one or more non-transitory computer-readable media of claim 17, wherein deduplicating the identified one or more template forms further comprises identifying the any duplicate forms based upon a common address associated with the identified one or more template forms

20. The one or more non-transitory computer-readable media of claim 17, wherein deduplicating the identified one or more template forms further comprises identifying the any duplicate forms based upon a common last name associated with the identified one or more template forms
